(19) United States
(12) Patent Application Publication
(10) Pub. No.: US 2007/0241884 A1
(43) Pub. Date: Oct. 18, 2007

(54) Information display apparatus, information display system and information display method

(75) Inventors: Akihisa Yamazaki, Asaka-shi (JP); Takeshi Misawa, Asaka-shi (JP); Sumie Mikami, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/727,523

(22) Filed: Mar. 27, 2007

(30) Foreign Application Priority Data
Mar. 28, 2006 (JP) 2006-089296

(51) Int. Cl. G08B 1/08

(52) U.S. Cl. 340/539.12; 707/101; 340/10.6; 340/825.36

(57) ABSTRACT

According to an information display apparatus of the present invention, the unique information optically transmitted from the instrument is acquired by the image pickup device. Of the acquired unique information, if there is information conforming to the specific unique information, the information corresponding thereto is extracted and displayed. To be more specific, the instrument is mounted on a specific object and the information on the object is stored so that the information on the object can be displayed as the unique information is acquired from the instrument mounted on the object by the image pickup device.

### BACKGROUND OF THE INVENTION

1. Field of the Invention

The present invention relates to a technology of acquiring information unique to an instrument by an image pickup device and displaying the information based on the acquired information unique to the instrument.

2. Description of the Related Art

Conventionally, there exists a technology of acquiring positional information from a photographed scenery image and acquiring information related to that position. Japanese Patent Application Laid-Open No. 2003-330953, Japanese Patent Application Laid-Open No. 2003-323440 and Japanese Patent Application Laid-Open No. 2002-247045 are related to such a technology.

In recent years, various technologies for intuitively and comprehensibly controlling a desired instrument with a single controller are developed. According to the following “Proposal of ‘OPTO-NAVI’ System, which is an information-appliance multi-purpose remote controller using a low power consumption ID-receiving CMOS image sensor having a function of reading a partial area at a high speed” (The Journal of the Institute of Image Information and Television Engineers Vol. 59, No. 12, pp. 1830-1840 (2005)) (hereinafter referred as “non-patent document”) for instance, a custom image sensor mounted on a cell-phone is used to receive an ID from the instrument while taking a normal image in real time. The received ID is superimposed on a taken background image and displayed on the display. A user can perform operation while viewing a subject instrument and the ID on the display.

### SUMMARY OF THE INVENTION

None of Japanese Patent Application Laid-Open No. 2003-330953, Japanese Patent Application Laid-Open No. 2003-323440, Japanese Patent Application Laid-Open No. 2002-247045 and the non-patent document discloses a concrete device for smoothly keeping on standby, leading or seeking a specific person among a large number of persons waiting for a product or service to be provided or a crowd coming and going in town. The present invention has been made in view of such a problem, and individually searches for a specific person and visually provides useful information on that person.

An information display apparatus according to the present invention comprises: an acquisition section which continuously acquires unique information optically transmitted from an instrument mounted on an object by one or multiple image pickup devices; an information storage section which stores information corresponding to the unique information; an extraction condition setting section which sets specific unique information as an extraction condition; an extraction section which extracts from the information storage section the information corresponding to the specific unique information conforming to the extraction condition set by the extraction condition setting section out of the unique information acquired by the acquisition section; and a display control section which controls the information extracted by the extraction section to be displayed on a display apparatus.

According to the present invention, the unique information optically transmitted from the instrument is acquired by the image pickup device. Of the acquired unique information, if there is information conforming to the specific unique information, the information corresponding thereto is extracted and displayed. To be more specific, the instrument is mounted on a specific object and the information on the object is stored so that the information on the object can be displayed as the unique information is acquired from the instrument mounted on the object by the image pickup device.

Furthermore, the unique information is optically transmitted, and so it is applicable even at places such as a hospital where it is inadequate to radiate an electromagnetic wave.

In particular, the information storage section may store queue information which is information on a queue corresponding to the unique information transmitted from the instrument mounted on each individual member of the queue as the information corresponding to the information unique to the instrument.

The extraction condition setting section can set specific unique information transmitted from the instrument mounted on a specific member of the queue or an attachment thereto as the extraction condition; and the extraction section can extract the queue information corresponding to the extraction condition set by the extraction condition setting section.

Here, the queue information includes at least one of time required to dissolve the queue to the specific member, number of members of the queue to the specific member, a place or a direction which the specific member should head for when the queue to the specific member is dissolved, and a matter which the specific member should complete before the queue to the specific member is dissolved.

It may further comprise a warning section for giving a predetermined warning to the specific member in the case where the time required to dissolve the queue to the specific member is shorter than a predetermined time.

It is thereby possible to prevent a person whose turn is about to come from leaving that place. The predetermined time may be appropriately set, such as one minute or five minutes.

Here, the specific member includes a lead member or a subsequent member of the queue.

To be more specific, in the case of a waiting list of a hospital or the like, the information can be displayed as to a patient whose turn has come and a patient whose turn is next.

The information display apparatus may further comprise a position identifying section for identifying a current position of the specific member based on an image acquired from an image pickup device of the acquisition section, and the display control section may control the display apparatus to leadingly display the place or direction which the specific member should head for when the queue to the specific member is dissolved according to the current position of the specific member identified by the location identifying section.

Thus, it is possible to visually indicate the place to which the patient and the like should move to so that even an unfamiliar person can easily reach a destination.

The acquisition section may also acquire the information on the object transmitted from the instrument, and the display apparatus may display the information on the object acquired by the acquisition section.

The information on the object includes physical information such as body temperature, blood pressure and pulse as well as a warning according to fluctuation of the physical information.

To be more specific, this apparatus can immediately give a warning in the case of a sudden change in the patient's condition.

The information display apparatus may further comprise an acquisition source identifying section for identifying the image pickup device having acquired the unique information which is the extraction condition set by the extraction condition setting section out of the multiple image pickup devices provided to the acquisition section, and the display control section may control an image acquired from the image pickup device identified by the acquisition source identifying section to be displayed on the display apparatus.

Thus, it is possible to display an image showing specific person.

The display control section may control the image acquired from the image pickup device identified by the acquisition source identifying section and the information extracted by the extraction section to be superimposed and displayed on the display apparatus.

The display control section may also control the image acquired from the image pickup device of the acquisition section and the information extracted by the extraction section to be superimposed and displayed on the display apparatus.

It is still better for the display control section to control the information extracted by the extraction section to be superimposed in proximity to a position where the specific unique information has been transmitted.

Thus, it is possible to visually recognize a relation between information and a subject and increase the effect of displaying the information.

An information display system according to the present invention comprises: an instrument which optically transmits unique information; an acquisition section which continuously acquires unique information optically transmitted from the instrument by one or multiple image pickup devices; an information storage section which stores information corresponding to the unique information; an extraction condition setting section for setting specific unique information as an extraction condition; an extraction section which extracts from the information storage section the information corresponding to the specific unique information conforming to the extraction condition set by the extraction condition setting section out of the unique information acquired by the acquisition section; and a display control section for controlling the information extracted by the extraction section to be displayed on a display apparatus.

An information display method according to the present invention comprises steps of: continuously acquiring unique information optically transmitted from an instrument mounted on an object by one or multiple image pickup devices; storing information corresponding to the unique information in a database; setting specific unique information as an extraction condition; extracting the information corresponding to specific unique information conforming to the set extraction condition out of the acquired unique information from the database; and controlling the extracted information to be displayed on a display apparatus.

According to the present invention, unique information optically transmitted from an instrument is acquired by the image pickup device. Of the acquired unique information, if there is any information conforming to specific unique information, the information corresponding thereto is extracted and displayed. To be more specific, if the instrument is mounted on a specific object and information on the object is stored, the information on the object can be displayed as the unique information is acquired from the instrument mounted on the object by the image pickup device. Moreover, the unique information is optically transmitted, and so it is applicable even at places such as a hospital where it is inadequate to radiate an electromagnetic wave.

### BRIEF DESCRIPTION OF THE DRAWINGS

FIG. 1 is a skeleton framework of an information delivery system;

FIG. 2 is a diagram showing an installation example of the information delivery system according to a first embodiment;

FIGS. 3A to 3C are diagrams showing mounting examples of an information transmission apparatus;

FIG. 4 is a block configuration diagram of the information transmission apparatus;

FIG. 5 is a block diagram of an information display apparatus;

FIG. 6 is a conceptual explanatory diagram of information stored in a database;

FIG. 7 is a flowchart showing a flow of a waiting person search process according to the first embodiment;

FIG. 8 is a diagram showing a state in which a next patient is visually displayed according to the information transmitted by the information transmission apparatus;

FIG. 9 is a diagram showing an appearance of calling a patient;

FIG. 10 is a block configuration diagram of the information transmission apparatus according to a second embodiment;

FIG. 11 is a flowchart showing the flow of the waiting person search process according to the second embodiment;

FIG. 12 is a diagram showing a state in which abnormality of a patient is visually displayed according to the information transmitted by the information transmission apparatus;

FIG. 13 is a diagram showing an appearance of the information display apparatus according to a third embodiment;

FIG. 14 is a diagram showing an installation example of the information delivery system according to the third embodiment;

FIG. 15 is a flowchart showing the flow of a waiting person warning process according to the third embodiment;

FIGS. 16A and 16B are diagrams showing a state in which a display according to a fourth embodiment displays directions to proceed according to positions of the patient;

FIGS. 17A and 17B are diagrams showing installation examples of a camera of the information delivery system according to a fifth embodiment; and

FIG. 18 is a flowchart showing the flow of the waiting person search process according to the fifth embodiment.

### DETAILED DESCRIPTION OF THE PREFERRED EMBODIMENTS

### First Embodiment

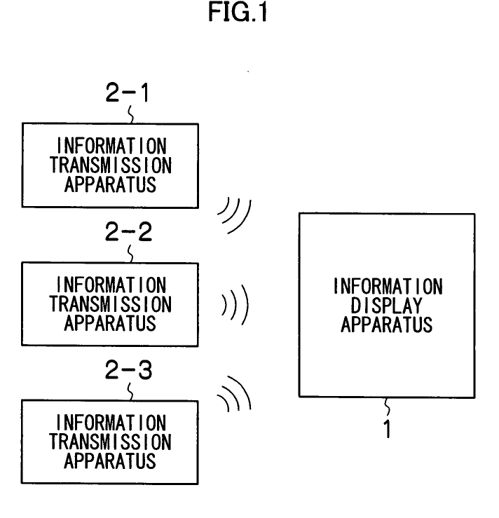

FIG. 1 is a skeleton framework of an information delivery system according to a first preferred embodiment of the present invention. This system includes an information display apparatus 1 and one or multiple information transmission apparatuses 2 which optically provide information to the information display apparatus 1.

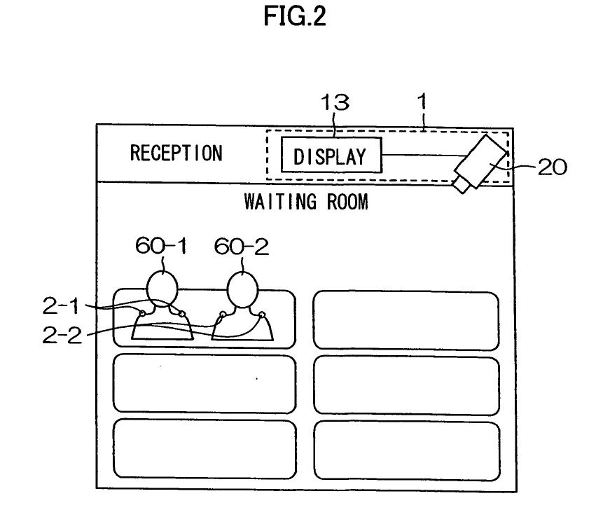

FIG. 2 shows an installation example of the information delivery system. The information display apparatus 1 is typically installed at a hospital reception and the like utilized by general public. Although the details will be described later, the information display apparatus 1 includes a display 13 which displays information and a camera section 20 which acquires the information optically transmitted from the information transmission apparatus 2. The camera section 20 is installed at a location for capturing as a subject a place where patients utilizing medical services gather, such as a waiting room of a hospital.

Information transmission apparatuses 2-1, 2-2 and so on are small portable instruments which are mounted on bodies of patients 60-1, 60-2 and so on or attachments to the patients.

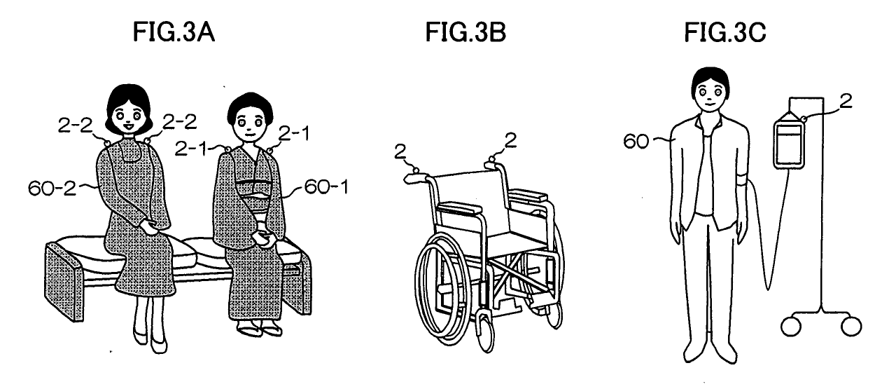

FIGS. 3A to 3C show appearances and mounting examples of the information transmission apparatus 2. The information transmission apparatus 2 is a small portable instrument which is mounted on bodies of the patients 60-1 and 60-2 (FIG. 3A) or attachments to the patients, such as a wheel chair (FIG. 3B), a drip cart (FIG. 3C), a walker and a crutch.

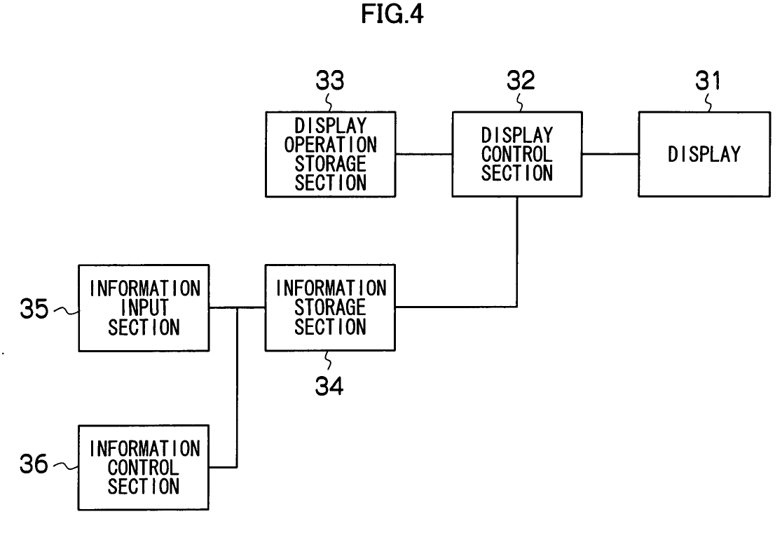

FIG. 4 is a detailed block diagram of the information transmission apparatus 2. The information transmission apparatus 2 includes a display 31, a display control section 32, a display operation storage section 33, an information storage section 34, an information input section 35 and an information control section 36.

The display 31 can be composed of an optical information transmission apparatus such as an LED illuminator.

The display control section 32 controls desired optical information transmission by controlling blinking of the illuminator of the display 31 according to an emission pattern stored in the display operation storage section 33 in advance. The information to be transmitted is provided from the information storage section 34.

The information input section 35 accepts input of any information to be transmitted by the display 31 from external instruments such as a thermometer and a blood pressure gauge. The information to be inputted may be character information, image information and the like. The information inputted from the information input section 35 is stored in the information storage section 34 composed of a storage medium such as a flash memory or a hard disk according to a command of the information control section 36. The information storage section 34 has the information unique (ID) to the information transmission apparatus 2 stored therein in advance.

The information control section 36 reads out the information stored in the information storage section 34 and provides it to the display control section 32 according to an instruction to start information transmission which is inputted by a user or automatically issued at a fixed time. The display control section 32 and the information storage section 34 do not need to be directly connected by a single route but may be connected via a network.

The display control section 32 controls the blinking of the illuminator of the display 31 in order to display the information such as an ID read out from the information storage section 34 on the display 31. Thus, optically identifiable information is transmitted from the display 31. As the display 31 does not transmit the information electromagnetically, it is safe without influencing various medical electronic devices, such as a pacemaker and an artificial respirator.

As for the information which irregularly changes or is desired to be unexpectedly displayed such as the information giving notice that the condition of the patient having the information transmission apparatus 2 mounted has deteriorated, necessary information should be inputted to the information input section 35 and immediately provided to the display control section 32 each time.

The display control section 32 controls frequencies as to all or part of the blinking of the illuminators of the display 31, and continuously transmits predetermined information read out from the storage section 34 as an optical signal difficult to visually recognize from the display 31. It may also be specified according to a user operation or the like by the information control section 36 as to whether to output the information as the optical signal difficult to visually recognize or output it as the optical signal visually identifiable from the display 31.

For instance, if the display 31 is composed of LED illuminators, it is difficult for an ordinary person to visually recognize blinking of an LED of about 60 Hz or more although it depends on luminance. Thus, the optical signal difficult to visually recognize is transmitted by blinking the LED between 60 Hz and several hundred Hz. If the frequency is increased, an amount of information transmittable by the optical signal also increases, which is an advantage. As there is a human visual feature of becoming sensitive to flickers in a bright place, however, it is desirable to transmit the optical signal at the frequency of 70 Hz to several hundred Hz or so. The information may also be transmitted by visible range outside light such as infrared light, and in particular, near infrared light because there is a possibility that blinking of the information transmission apparatuses 2 of the patients may hinder smooth operation of the hospital.

The display control section 32 controls the display 31 to superpose a low-frequency pilot signal which indicates the location of an information transmission section in the display 31 over the optical signal. If a luminescent device of the display 31 is the LED and there is modulation of luminance (change in a luminance level) at a low frequency from the beginning, the pilot signal should be superposed by utilizing the modulation of luminance. As ordinary people are used to the blinking of the illuminators of an electric bulletin board, they do not sense discomfort at transmission of the pilot signal by the modulation of luminance.

There are also other thinkable methods, such as modulating the luminance of a section for emitting light in a specific color (a single-color LED can have a wavelength specified) to a fixed value or more at a low frequency. In this case, it is desirable to provide an upper limit of the modulation of detected luminance on a receiving side since there is a possibility that the receiving side (information display apparatus 1) may falsely detect reflected light from the sun or other light sources as the pilot signal.

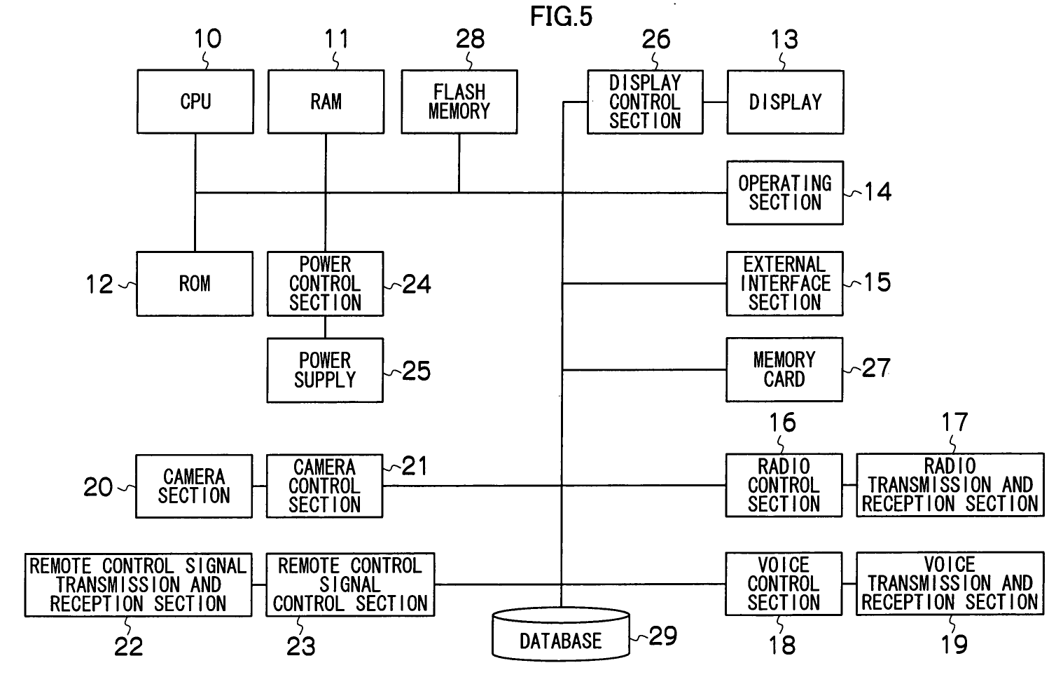

FIG. 5 is a functional block diagram of the information display apparatus 1. The information display apparatus 1 includes the camera section 20 including an image pickup lens, a solid-state image pickup device such as a CMOS or a CCD image sensor, an analog front end circuit for processing an analog image read from the solid-state image pickup device by a driver into a digital signal, a signal processing circuit such as a DSP (Digital Signal Processor) for processing a digital image signal from the analog front end circuit, and the like, and a camera control section 21 which is composed of one-chip microcomputer and the like and controls imaging operation of the camera section 20.

The information display apparatus 1 also includes a display control section 26 which controls display of the display 13 according to input operation to an operating section 14 composed of a touch panel, a numeric keypad and the like, various operation signals received from outside by a remote control signal transmission and reception section 22 and an image and an optical signal acquired by the camera section 20.

The information display apparatus 1 further includes a CPU 10 which exerts centralized control over operation of the sections, an ROM 12 which stores various kinds of data and programs, an RAM 11 which stores various kinds of data necessary for processing of the CPU 10, and a database 29 which stores various kinds of information associated with the information unique to each of the information transmission apparatuses 2.

Especially in the ROM 12, there are stored, for each of the information transmission apparatuses 2, a control program for the CPU 10 to control each section in accordance with an operation of the operation section 14, and remote control GUI for visually displaying the relation between the taken image and the received information.

For example, an optical double zoom lens is used as the image-taking lens, and the optical zoom magnification is changed by a motor driver forward and backward driving the image-taking lens to the telephotographic (tele) side or the wide-angle (wide) side in accordance with a magnification change operation inputted from the operation section 14. The magnification of the image-taking lens is not limited to the above. An aperture is provided for the image-taking lens. An appropriate amount of exposure is obtained by controlling the aperture via the motor driver.

When the photographing mode is set by the operation section 14, the CPU 10 displays a motion picture (live images) on the display section 13 to enable confirmation of the image-taking angle of field. That is, the solid-state image pickup device converts a light of a subject which is incident through the image-taking lens and is formed on the light-receiving surface of the image pickup device to an amount of signal charge corresponding to the amount of the light. The signal charges of respective pixels accumulated in this way are sequentially and individually read by the driver as voltage signals (image signals) corresponding to the signal charges, based on a driving pulse given by a timing generator in accordance with a direction from the CPU 10 and converted to digital signals in the analog front-end circuit, and each of them is added to the signal processing circuit.

The signal processing circuit includes a gain adjustment circuit and an A/D converter. It is an image processing device which includes a brightness/color difference signal generation circuit, a gamma correction circuit, a sharpness correction circuit, a contrast correction circuit, a white balance correction circuit, an outline processing section for performing imaging processing including outline correction for a taken image, a noise reduction processing section for performing noise reduction processing of an image and the like, and it processes an image signal in accordance with a command from the CPU 10.

The image data inputted into the signal processing circuit is converted to a brightness signal (Y signal) and a color difference signal (Cr/Cb signal), and the signals are stored in the VRAM after predetermined processings such as gamma correction is performed therefor.

When the monitor output of a taken image to the display section 13 is performed, a Y/C signal is read from the VRAM and sent to a display control section 26. The display control section 26 converts the inputted Y/C signal to a signal of a predetermined method for display (for example, a compound color picture signal of an NTSC method) and outputs it to the display section 13.

The Y/C signals of respective frames which have been processed at a predetermined frame rate are written in an A area and a B area of the VRAM alternatively, and a written Y/C signal is read not from the area in which a Y/C signal is being written but from the other area, between the A and B areas. By the Y/C signals in the VRAM being periodically overwritten, and picture signals generated from the Y/C signals being provided for the display section 13, the picture being taken is displayed on the display section 13 in real time. The user can confirm the image-taking angle of field by the picture (live images) displayed on the display section 13.

Here, when a photographing key provided on the operation section 14 is pressed, a photographing operation for storage is started. Image data acquired in response to the pressing of the photographing key is converted to a brightness/color difference signal (Y/C signal) in the signal processing circuit, and it is stored in the RAM 11 after predetermined processings such as gamma correction are performed therefor.

The Y/C signal stored in the RAM 11 is compressed in accordance with a predetermined format by a compression/expansion processing circuit and then stored in a memory card 27 as an image file in a predetermined format such as an Exif file. The image file can also be stored in a flash memory 28.

When the reproduction mode is set by the operation section 14, the compressed data of the final image file stored in the flash memory 28 (a file stored last) is read. When the file stored last is a still image file, the read compressed image data is expanded to an uncompressed Y/C signal via the compression/expansion processing circuit and stored in the VRAM. The Y/C signal stored in the VRAM is added to the display control section 26. The display control section 26 creates a compound RGB color picture signal of the NTSC method from the inputted Y/C signal and outputs it to the display section 13. Thereby, the frame image of the last frame stored in the memory card 27 is displayed on the display section 13.

After that, when the right key of a cross key provided on the operation section 14 is pressed, frame advancing is performed in the forward direction, and when the left key of the cross key is pressed, frame returning is performed in the opposite direction. Then, an image file at the frame position set by the frame advancing or returning is read from the memory card 27, and a frame image is reproduced on the display section 13 similarly as described above. If frame advancing is performed in the forward direction when the frame image of the last frame is displayed, the image file of the first frame stored in the memory card 27 is read, and the frame image of the first frame is reproduced on the display section 13.

The number of pixels of an image file to be stored is, for example, any of 2832×2128 (6 M), 2048×1536 (3 M), 1280×960 (1 M) and 640×480 (VGA), and the amount of data of a taken image (the file size) changes according to the combination of the stored image quality and the number of stored pixels.

If the camera section 20 takes an image of the information transmission apparatus 2 as a subject, it is possible to acquire the information optically transmitted by each of the information transmission apparatuses 2 together with the image.

The camera control section 21 transforms the information superposed on the optical signal incident from the external information transmission apparatus 2 into digital data and outputs it to the CPU 10.

The information display apparatus 1 further includes a radio transmission and reception section 17 which transmits and receives a radio signal not influencing the medical electronic devices such as IrDA to and from various electronic devices such as a personal computer, a radio control section 16 which converts a received radio signal into data and transmits it to the CPU 10 or superposes a remote control signal directed by the CPU 10 on the radio signal, and an external interface section 15 which communicates with the instruments such as the personal computer, a server and a printer in compliance with standards such as TCP/IP via a network such as an LAN.

Basically, information is provided from the information transmission apparatus 2 to the information display apparatus 1 by optical communication. In the case of acquiring a large amount of information from the information transmission apparatus 2, however, desired information may be acquired by accessing the information transmission apparatus 2 or other instruments via the network, which will not be referred to in detail here.

The information display apparatus 1 includes a voice transmission and reception section 19 including an amplifying device such as a speaker which makes sounds, a voice receiving device such as a microphone which receives sounds and converts them to electrical signals and a communication device which transmits and receives sound signals to and from the other end by wire or wirelessly, and a voice control section 18 which controls utterance contents of the amplifying device. The voice control section 18 has a function of recognizing a specific sound pattern specified by the CPU 10 from the sound signal inputted from the voice transmission and reception section 19.

The CPU 10 can also control each individual block according to the sound received by the voice transmission and reception section 19. To be more specific, the control over each individual block is not limited to the input operation to the operating section 14 but may also be exerted by voice input.

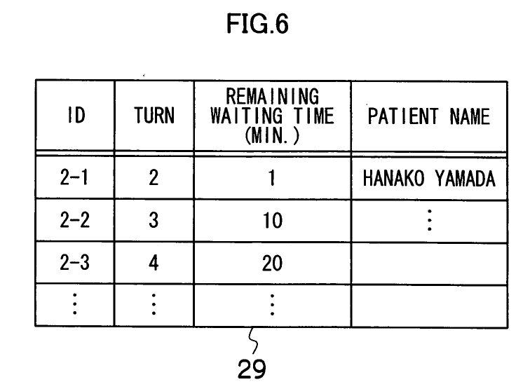

FIG. 6 shows an example of the information stored in the database 29 provided to the information display apparatus 1. Here, the information unique to the information transmission apparatus 2 mounted on each of the patients or the attachment to the patient, that is, the ID is stored in association with the patient's turn in the queue until receiving the medical services such as a diagnosis and a checkup, remaining waiting time which is the time required to dissolve the queue, and the patient's name.

For instance, the ID of the information transmission apparatus 2 mounted on the patient whose turn in the queue is the first (that is, a head of the queue) is “2-1.” As for the names of the patients corresponding to the IDs of the information transmission apparatuses 2 mounted on them, a staffer registers them with the database 29 via the operating section 14 of the information display apparatus 1 when accepting the patients to be on the waiting list.

Here, the information to be associated with the IDs does not need to be limited to that shown in FIG. 6. For instance, the information to be associated with the IDs may be the number of members of the queue, a place or a direction which the patient should head for when the queue is dissolved, and a matter which the patient or a medical staffer should complete before the queue is dissolved.

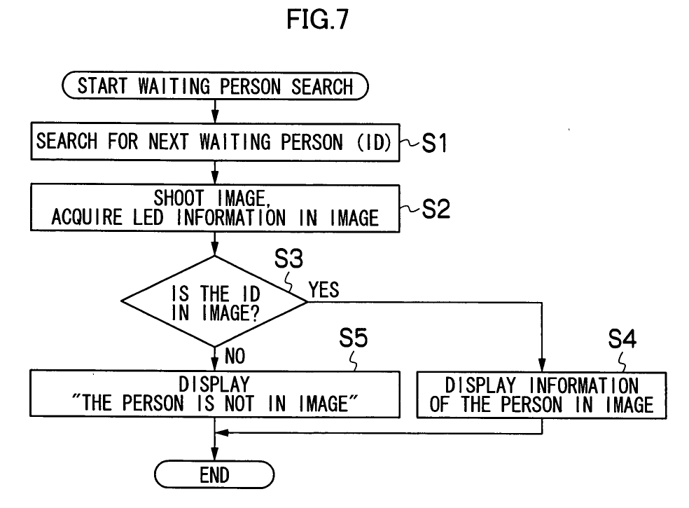

FIG. 7 is a flowchart showing a flow of a waiting person search process executed by the information display apparatus 1.

In S1, the CPU 10 acquires the ID corresponding to a turn next to the head of the queue from the database 29, and sets this ID as a search condition of information. The turn in the queue of the database 29 is immediately updated as the queue is sequentially dissolved.

In S2, the CPU 10 orders the camera control section 21 to start operation to acquire a still image. The camera control section 21 acquires the still image by controlling the camera section 20, and stores it in the RAM 11. The CPU 10 determines whether or not at least one pilot signal of the information transmission apparatus 2 has been detected from the image acquired by the camera section 20. If determined that at least one pilot signal has been detected, the CPU 10 identifies an information transmission location based on a detected location of the pilot signal. And the operation to acquire a still image is performed again at a high frame rate as to the portion of the information transmission location and at a low frame rate as to the other portions so as to extract the ID superposed on the portion of the information transmission location.

In S3, it is determined whether or not there is an ID conforming to the search condition set in S1 among the extracted IDs. It moves on to S4 in the case where there is an ID conforming to the search condition, and moves on to S5 in the case where there is none.

In S4, the CPU 10 extracts the information corresponding to the ID conforming to the search condition (conforming ID) from the database 29. And the extracted information or information equivalent or related thereto (such as the turn to receive the service being next and the name of the next patient, which information will be represented hereunder by extraction information and the like) is superposed in proximity to the information transmission location at which the conforming ID was extracted in the image acquired by the camera section 20 so as to display the image having the information superposed thereon on the display 13. It is also possible to superimpose on the image a picture of an arrow or the like indicating the information transmission location at which the conforming ID was extracted.

For instance, the patient 60-1 is the second in the queue, and an ID “2-1” of the information transmission apparatus 2-1 mounted on the patient 60-1 and the turn in the queue “2” are associated and stored in the database 29.

If the waiting person search process is executed in this case, the extraction information and the like are superposed in proximity to the information transmission location of the information transmission apparatus 2-1 mounted on the second patient 60-1 in the image acquired by the camera section 20 so as to be displayed on the display 13.

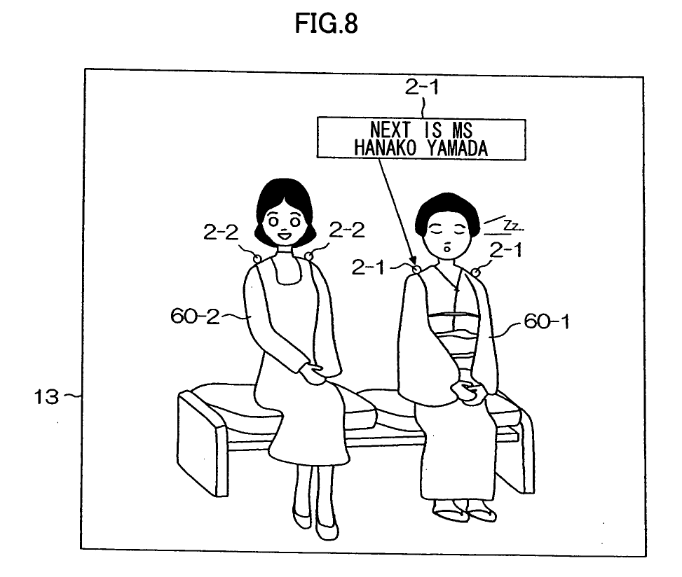

FIG. 8 shows an example in which the extraction information and the like corresponding to the conforming ID are superimposed on the image and displayed on the display 13. Here, the patient 60-1 is the second in the queue so that the extraction information or the like stating “the next patient is Ms. Hanako Yamada” is displayed in proximity to the patient 60-1. The hospital staff can grasp who is the next patient to be led to a consultation room or an examination room just by looking at the indication on the display 13.

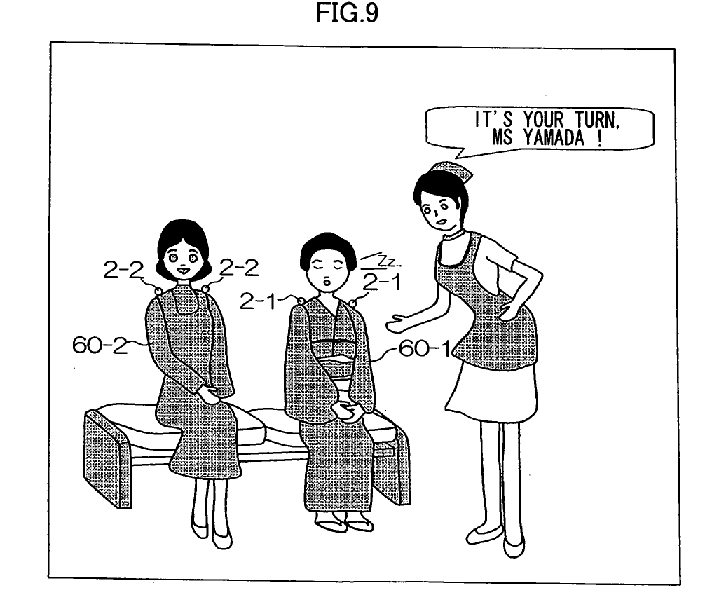

Conventionally, it is difficult to identify the patient 60-1 in the case where the patient 60-1 falls asleep while on the waiting list and does not respond to the staffer's call. While it is thinkable to identify and call the patient by using an apparatus emitting an electric wave such as a cell-phone, it is not desirable in view of the influence on the medical electronic devices. According to this system, however, it is possible, without using the instrument which electromagnetically transmits the information, to display the extraction information or the like in proximity to the specific patient 60-1 so as to visually identify the patient 60-1 and indicate that the patient's turn has come (FIG. 9).

### Second Embodiment

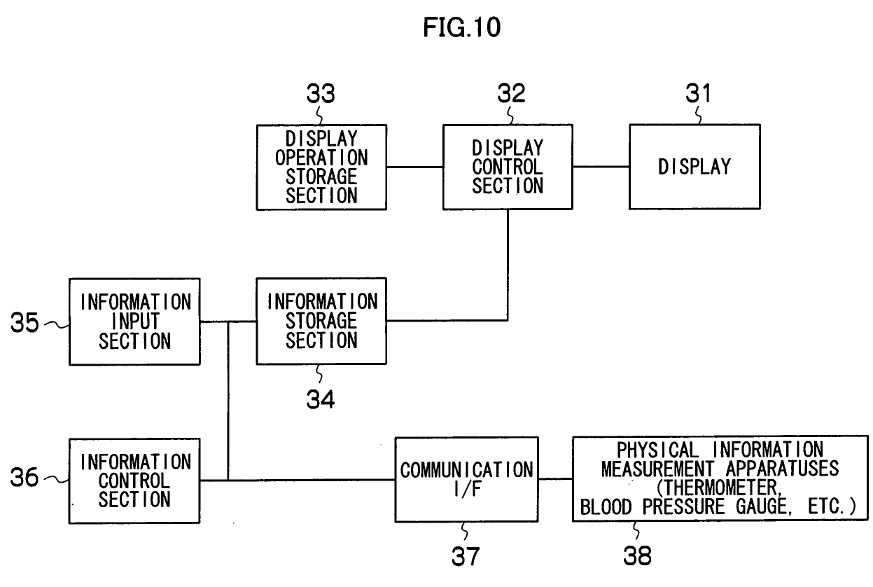

As shown in FIG. 10, the information transmission apparatus 2 can transmit from the display 31 physical information of the patient such as body temperature and blood pressure inputted to the information input section 35 from external (or integrally configured with the information transmission apparatus 2) physical information measurement apparatuses 38 such as a thermometer and a blood pressure gauge via a communication interface 37.

Furthermore, the information transmission apparatus 2 may monitor fluctuation in the physical information and transmit abnormality information indicating that an abnormality has occurred to the patient together with the ID in the case where the fluctuation out of a preset allowable range is monitored.

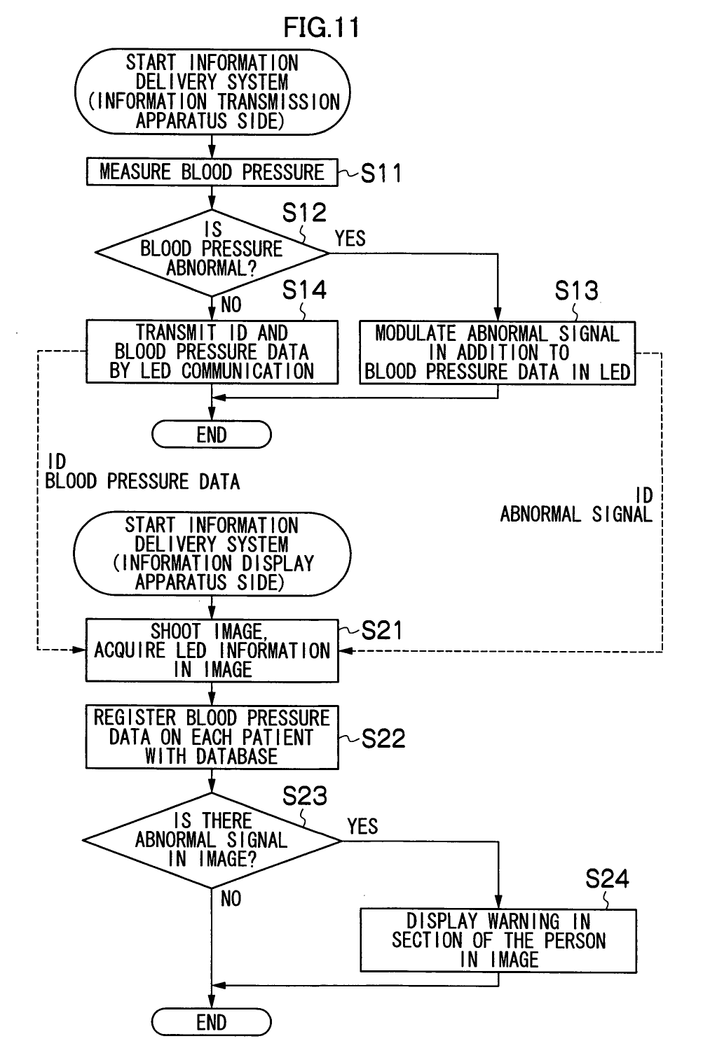

FIG. 11 is a flowchart showing the flow of a waiting person search process according to a second embodiment. Here, reference characters S11 to S14 designate the process on the information transmission apparatus 2 side while reference characters S21 to S24 designate the process on the information display apparatus 1.

In S11, the physical information measurement apparatuses measure the physical information of the patient, and input the measured physical information to the information input section 35.

In S12, the information transmission apparatus 2 determines whether or not the inputted physical information is numerical values out of a predetermined allowable range. If out of the allowable range, it moves on to S13. If within the allowable range, it moves on to S14.

In S13, the display 31 optically transmits the ID, physical information and abnormality information.

In S14, the display 31 optically transmits the ID and physical information.

In S21, the CPU 10 performs the same operation as in S2, and extracts the still image and the ID and physical information superposed on the section of the information transmission location. It also extracts the abnormality information in the case where the abnormality information is transmitted.

In S22, the CPU 10 associates the acquired physical information with the ID to store them in the database 29. If a desired ID is specified from the operating section 14, the physical information corresponding to the ID is displayed on the display 13 so that the patient's condition can be referred to as appropriate.

In S23, it is determined whether or not the abnormality information was extracted in S21. In the case where the abnormality information was extracted, it moves on to S24.

In S24, the abnormality information or information related thereto (represented by the abnormality information hereafter) is superposed in proximity to the information transmission location at which the abnormality information was acquired in the image acquired by the camera section 20 so as to be display it on the display 13.

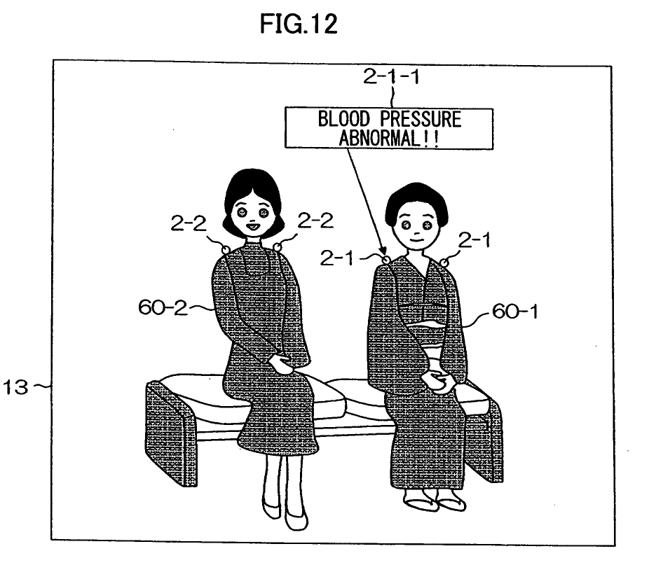

FIG. 12 shows a display example of the abnormality information and the like. Here, the abnormality information on blood pressure was transmitted from the information transmission apparatus 2 mounted on the patient 60-1, and so abnormality information and the like 2-1-1 stating “blood-pressure abnormal!!” is displayed in proximity to the patient 60-1.

To be more specific, this system can visually indicate the abnormality of the specific patient 60-1 and visually specify the patient to whom the abnormality has occurred at once without using the apparatus which electromagnetically transmits the information.

### Third Embodiment

The form of installation of the information display apparatus 1 is not limited to that shown in FIG. 2 but is variously changeable according to application.

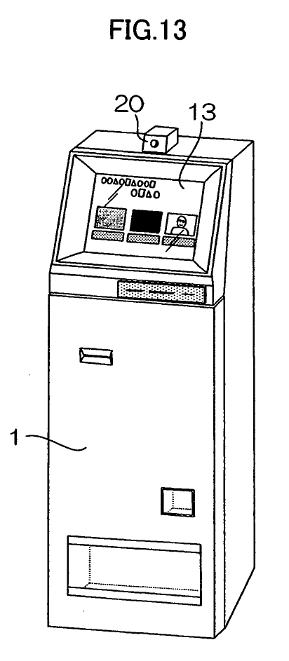

As shown in FIG. 13 for instance, a terminal-type information display apparatus 1 having the camera section 20 mounted at the top of its cabinet and the display 13 mounted on its front is configured. If a person having the information transmission apparatus 2 mounted such as the patient moves to the front of the information display apparatus 1, the camera section 20 which captures that position in its angle of view can acquire the ID transmitted from the information transmission apparatus 2.

And then, the display 13 displays the extraction information and the like, such as the waiting time corresponding to the ID, the number of persons on the waiting list, the place which the patient should head for when his or her turn comes, and entries and measurement items required during the waiting time.

On seeing the extraction information, the patient can visually recognize how long to wait, what to do while waiting or what place to head for when his or her turn comes.

The extraction information can be printed out by the printer connected via the external interface section 15 and given to the patient.

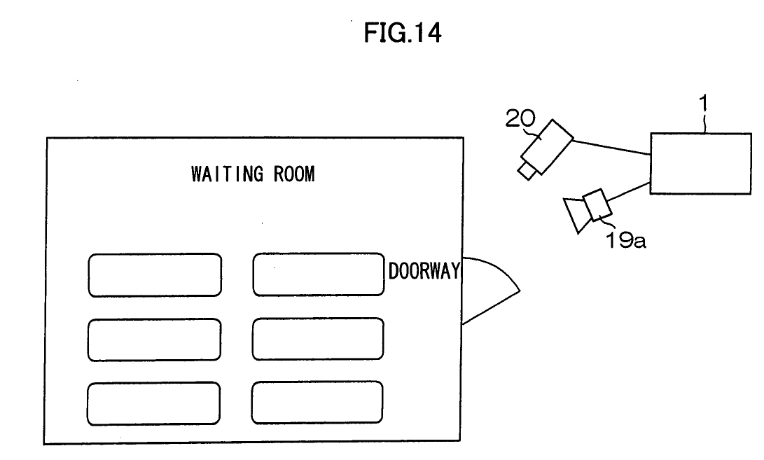

Or else, as shown in FIG. 14, the camera section 20 is installed to capture vicinity of a doorway of a waiting room in its angle of view, and a speaker 19a (the speaker included in the voice transmission and reception section 19) which amplifies the voice is installed in the vicinity of the doorway of the waiting room.

A warning is given from the speaker 19a when the patient whose remaining waiting time is short tries to go out of the doorway.

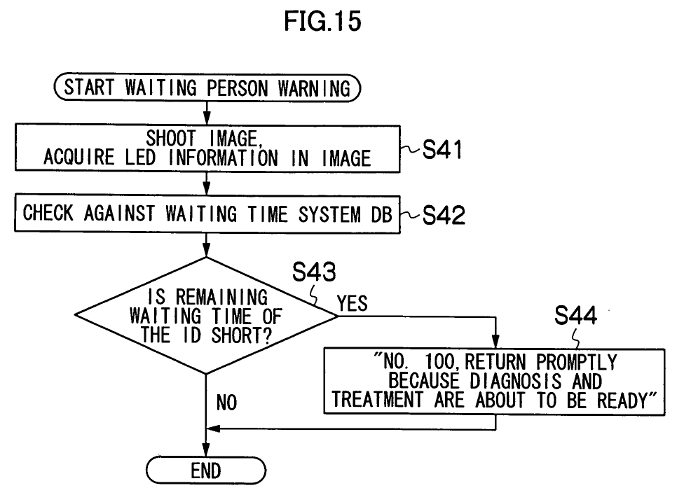

FIG. 15 is a flowchart showing the flow of a waiting person warning process.

First, the camera section 20 acquires the still image and the ID in S41 as in S2 and the like.

In S42, of the waiting times stored in the database 29, the ID corresponding to the waiting time less than a predetermined threshold is specified as a warning subject ID.

In S43, it is determined whether or not there is an ID matching with the warning subject ID among the IDs acquired by the camera section 20. If there is a matching ID, it moves on to S44.

In S44, the name of the patient corresponding to the warning subject ID and the voice which warns that the service such as the diagnosis is shortly provided are outputted from the speaker 19a. However, the device which gives a warning is not limited to the speaker 19a but may be the information display apparatus such as the display 13 or an electric bulletin board. It is also possible to use both of them.

Thus, it is possible to prevent the patient whose turn has come from going away because, even if the patient tries to go out of the waiting room while waiting, the warning can be given by calling the patient's name whose turn is shortly coming.

### Fourth Embodiment

The display 13 does not necessarily have to display the extraction information in video and does not need to be composed of a graphic display apparatus such as a liquid crystal display. Therefore, it is also possible to display the information in a display pattern of a lighting instrument such as a guide light, an emergency lamp or an electric bulletin board.

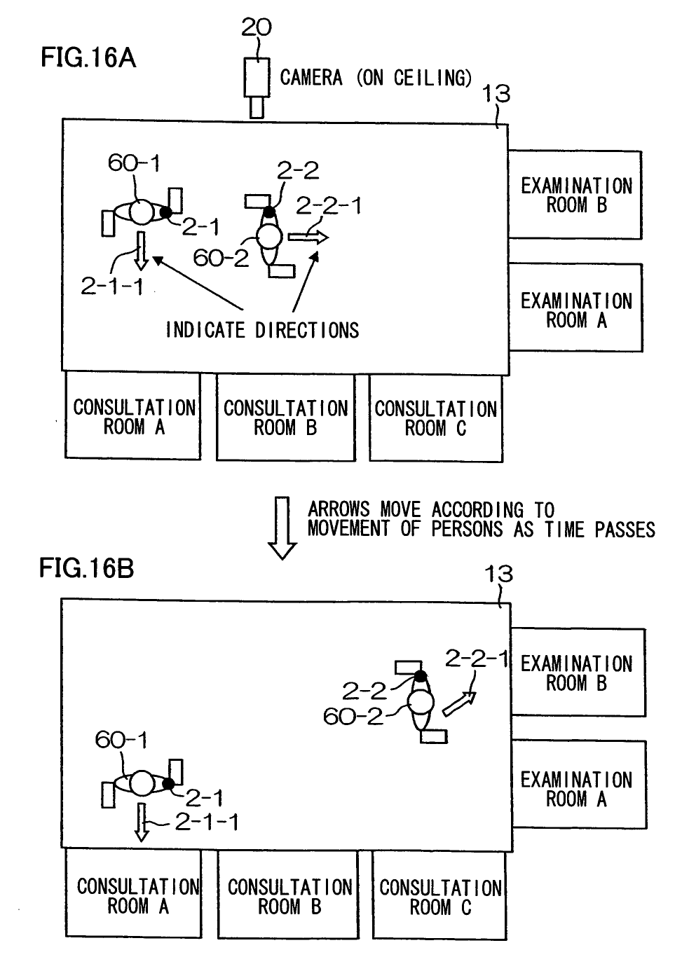

As shown in FIGS. 16A and 16B for instance, the positions of the patients 60-1, 60-2 and so on are identified from the information transmission locations of the information transmission apparatuses 2-1, 2-2 and so on mounted on the patients 60-1, 60-2 and so on acquired from the camera section 20 so as to indicate the direction or the place which the patients 60-1, 60-2 and so on should head for on the display 13 according to the positions of the patients 60-1, 60-2 and so on. Here, the direction which the patients 60-1 and 60-2 should head for is indicated by large arrows 2-1-1 and 2-2-1 formed by a light emitting pattern on the display 13 buried in a floor surface (FIG. 16A).

The arrows 2-1-1 and 2-2-1 change according to current positions, a current moving direction and the direction for an objective point of the patients 60-1 and 60-2 (FIG. 16B). The current moving direction can be detected from a difference between the information transmission locations of the information transmission apparatuses 2-1 and 2-2. The patients can arrive at an expected place just by proceeding in the direction of the arrows 2-1-1, 2-2-1 indicated to them. It is very convenient in the place where rooms are complicated such as a large hospital or for an unfamiliar person such as a first user.

### Fifth Embodiment

It is also possible to install the camera sections 20 of this system at multiple locations in a large area so that a specific person existing in angle of view of each of the camera sections 20 can be detected.

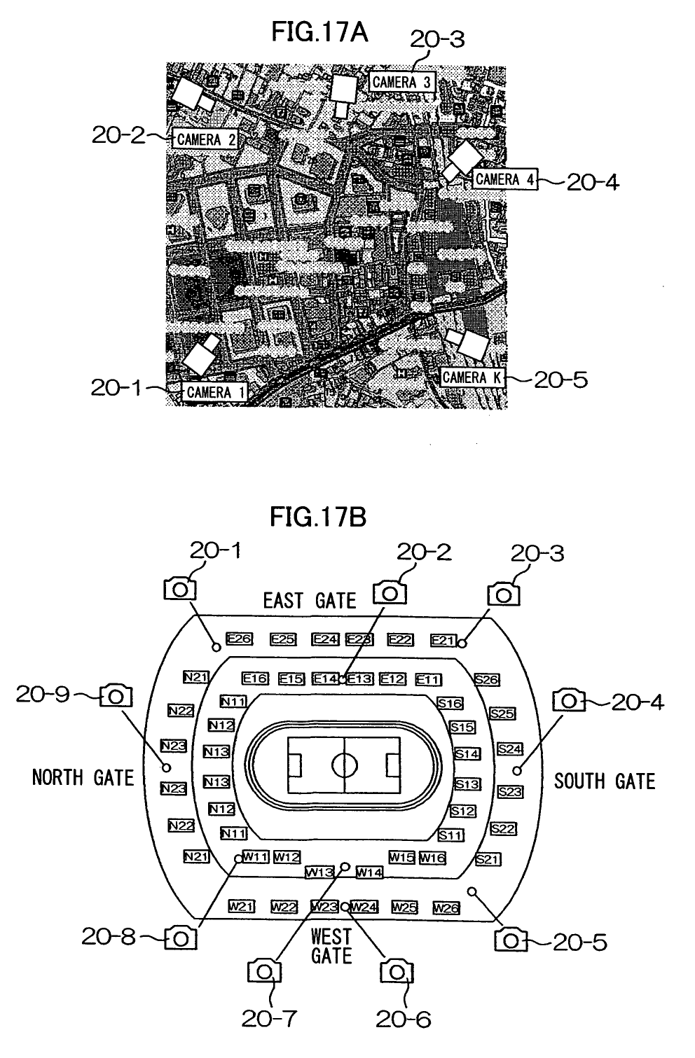

For instance, the camera sections 20 are installed at multiple locations in town as shown in FIG. 17A or installed at multiple locations of a certain arena as shown in FIG. 17B so as to have predetermined areas covered by the angles of view of the multiple camera sections 20. K pieces of the camera section 20 are installed, where the camera sections 20 are given identification numbers 1 to K respectively.

The information transmission apparatuses 2 are mounted in advance on persons to be searched for, such as children and elderly people. It is also possible to mount the information transmission apparatus 2 on the attachment such as a school bag rather than mounting it directly on the body of one's child.

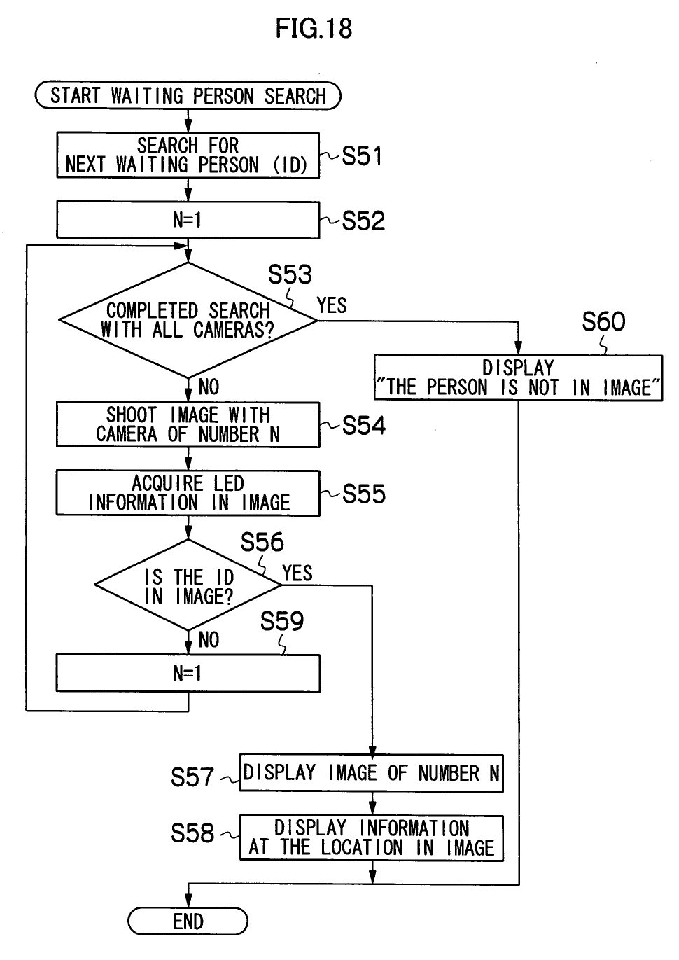

FIG. 18 is a flowchart showing the flow of the waiting person search process according to a fifth embodiment.

In S51, the ID of the information transmission apparatus 2 mounted on a desired person to search for is set as the search condition. The search condition is set from the operating section 14.

In S52, a parameter N of the identification number of the camera section 20 is 1.

In S53, it is determined whether or not N≧K. If N≧K, it moves onto S60. If N<K, it moves onto S54.

In S54, the camera section 20 of the number N acquires the still image.

In S55, the camera section 20 of the number N detects the pilot signal and acquires the IDs.

In S56, of the IDs acquired by the camera section 20 of the number N, it is determined whether or not there is an ID conforming to the search condition. In the case where there is the ID conforming to the search condition, it moves on to S57. In the case where there is none, it moves on to S59.

In S57, the still image acquired by the camera section 20 of the number N is displayed on the display 13. It is also possible to output the still image acquired by the camera section 20 of the number N to a desired display apparatus connected via the external interface section 15 or the radio transmission and reception section 17.

In S58, the information corresponding to the ID conforming to the search condition is extracted from the database, and is superposed on the still image. In the cases such as searching for one's own children, however, it may be omitted because there is little need to display the names and the like.

In S59, N is incremented, and it returns to S53.

In S60, the display 13 displays a message to the effect that none of the camera sections 20 could capture the searched person in the angle of view.

Thus, if the information transmission apparatus 2 is mounted on the desired person or his or her attachment and any one of the camera sections 20 acquires the ID of the information transmission apparatus 2, the image of the camera section 20 capturing the person can be displayed, which is helpful in a search for a missing child or elderly person.

What is claimed is:

1. An information display apparatus comprising:
an acquisition section which continuously acquires unique information optically transmitted from an instrument mounted on an object by one or multiple image pickup devices;
an information storage section which stores information corresponding to the unique information;
an extraction condition setting section which sets specific unique information as an extraction condition;
an extraction section which extracts from the information storage section the information corresponding to the specific unique information conforming to the extraction condition set by the extraction condition setting section out of the unique information acquired by the acquisition section; and
a display control section which controlling the information extracted by the extraction section to be displayed on a display apparatus.

2. The information display apparatus according to claim 1, wherein the information storage section stores queue information which is information on a queue corresponding to the unique information transmitted from the instrument mounted on each individual member of the queue as the information corresponding to the information unique to the instrument.

3. The information display apparatus according to claim 2, wherein:
the extraction condition setting section sets specific unique information transmitted from the instrument mounted on a specific member of the queue or an attachment thereto as the extraction condition; and
the extraction section extracts the queue information corresponding to the extraction condition set by the extraction condition setting section.

4. The information display apparatus according to claim 3, wherein the queue information includes at least one of time required to dissolve the queue to the specific member, number of members of the queue to the specific member, a place or a direction which the specific member should head for when the queue to the specific member is dissolved, and a matter which the specific member should complete before the queue to the specific member is dissolved.

5. The information display apparatus according to claim 3, further comprising a warning section which gives a predetermined warning to the specific member in the case where the time required to dissolve the queue to the specific member is shorter than a predetermined time.

6. The information display apparatus according to claim 4, further comprising a warning section which gives a predetermined warning to the specific member in the case where the time required to dissolve the queue to the specific member is shorter than a predetermined time.

7. The information display apparatus according to claim 3, wherein the specific member includes a lead member or a subsequent member of the queue.

8. The information display apparatus according to claim 3, further comprising a position identifying section which identifies a current position of the specific member based on an image acquired from an image pickup device of the acquisition section,
wherein the display control section controls the display apparatus to leadingly display the place or direction which the specific member should head for when the queue to the specific member is dissolved according to the current position of the specific member identified by the location identifying section.

9. The information display apparatus according to claim 6, further comprising a position identifying section which identifies a current position of the specific member based on an image acquired from an image pickup device of the acquisition section,
wherein the display control section controls the display apparatus to leadingly display the place or direction which the specific member should head for when the queue to the specific member is dissolved according to the current position of the specific member identified by the location identifying section.

10. The information display apparatus according to claim 7, further comprising a position identifying section which identifies a current position of the specific member based on an image acquired from an image pickup device of the acquisition section,
wherein the display control section controls the display apparatus to leadingly display the place or direction which the specific member should head for when the queue to the specific member is dissolved according to the current position of the specific member identified by the location identifying section.

11. The information display apparatus according to claim 1, wherein:
the acquisition section acquires information on the object transmitted from the instrument; and
the display apparatus displays the information on the object acquired by the acquisition section.

12. The information display apparatus according to claim 9, wherein:
the acquisition section acquires information on the object transmitted from the instrument; and
the display apparatus displays the information on the object acquired by the acquisition section.

13. The information display apparatus according to claim 10, wherein:
the acquisition section acquires information on the object transmitted from the instrument; and
the display apparatus displays the information on the object acquired by the acquisition section.

14. The information display apparatus according to claim 11, wherein the information on the object includes physical information such as body temperature, blood pressure and pulse as well as a warning according to fluctuation in the physical information.

15. The information display apparatus according to claim 12, wherein the information on the object includes physical information such as body temperature, blood pressure and pulse as well as a warning according to fluctuation in the physical information.

16. The information display apparatus according to claim 13, wherein the information on the object includes physical information such as body temperature, blood pressure and pulse as well as a warning according to fluctuation in the physical information.

17. The information display apparatus according to claim 1, further comprising an acquisition source identifying section which identifies the image pickup device having acquired the unique information which is the extraction condition set by the extraction condition setting section out of the multiple image pickup devices provided to the acquisition section,
wherein the display control section controls an image acquired from the image pickup device identified by the acquisition source identifying section to be displayed on the display apparatus.

18. The information display apparatus according to claim 14, further comprising an acquisition source identifying section which identifies the image pickup device having acquired the unique information which is the extraction condition set by the extraction condition setting section out of the multiple image pickup devices provided to the acquisition section,
wherein the display control section controls an image acquired from the image pickup device identified by the acquisition source identifying section to be displayed on the display apparatus.

19. The information display apparatus according to claim 15, further comprising an acquisition source identifying section which identifies the image pickup device having acquired the unique information which is the extraction condition set by the extraction condition setting section out of the multiple image pickup devices provided to the acquisition section,
wherein the display control section controls an image acquired from the image pickup device identified by the acquisition source identifying section to be displayed on the display apparatus.

20. The information display apparatus according to claim 16, further comprising an acquisition source identifying section which identifies the image pickup device having acquired the unique information which is the extraction condition set by the extraction condition setting section out of the multiple image pickup devices provided to the acquisition section,
wherein the display control section controls an image acquired from the image pickup device identified by the acquisition source identifying section to be displayed on the display apparatus.

21. The information display apparatus according to claim 17, wherein the display control section controls the image acquired from the image pickup device identified by the acquisition source identifying section and the information extracted by the extraction section to be superimposed and displayed on the display apparatus.

22. The information display apparatus according to claim 18, wherein the display control section controls the image acquired from the image pickup device identified by the acquisition source identifying section and the information extracted by the extraction section to be superimposed and displayed on the display apparatus.

23. The information display apparatus according to claim 19, wherein the display control section controls the image acquired from the image pickup device identified by the acquisition source identifying section and the information extracted by the extraction section to be superimposed and displayed on the display apparatus.

24. The information display apparatus according to claim 20, wherein the display control section controls the image acquired from the image pickup device identified by the acquisition source identifying section and the information extracted by the extraction section to be superimposed and displayed on the display apparatus.

25. The information display apparatus according to claim 1, wherein the display control section controls the image acquired from the image pickup device of the acquisition section and the information extracted by the extraction section to be superimposed and displayed on the display apparatus.

26. The information display apparatus according to claim 14, wherein the display control section controls the image acquired from the image pickup device of the acquisition section and the information extracted by the extraction section to be superimposed and displayed on the display apparatus.

27. The information display apparatus according to claim 15, wherein the display control section controls the image acquired from the image pickup device of the acquisition section and the information extracted by the extraction section to be superimposed and displayed on the display apparatus.

28. The information display apparatus according to claim 16, wherein the display control section controls the image acquired from the image pickup device of the acquisition section and the information extracted by the extraction section to be superimposed and displayed on the display apparatus.

29. The information display apparatus according to claim 21, wherein the display control section controls the information extracted by the extraction section to be superimposed in proximity to a position where the specific unique information has been transmitted.

30. The information display apparatus according to claim 25, wherein the display control section controls the information extracted by the extraction section to be superimposed in proximity to a position where the specific unique information has been transmitted.

31. An information display system comprising:
an instrument which optically transmits unique information;
an acquisition section which continuously acquires unique information optically transmitted from the instrument by one or multiple image pickup devices;
an information storage section which stores information corresponding to the unique information;
an extraction condition setting section which sets specific unique information as an extraction condition;
an extraction section which extracts from the information storage section the information corresponding to the specific unique information conforming to the extraction condition set by the extraction condition setting section out of the unique information acquired by the acquisition section; and
a display control section which controls the information extracted by the extraction section to be displayed on a display apparatus.

32. An information display method comprising steps of:
continuously acquiring unique information optically transmitted from an instrument mounted on an object by one or multiple image pickup devices;
storing information corresponding to the unique information in a database;
setting specific unique information as an extraction condition;
extracting the information corresponding to specific unique information conforming to the set-up extraction condition out of the acquired unique information from the database; and
controlling the extracted information to be displayed on a display apparatus.
